(19) United States
(12) Patent Application Publication
(10) Pub. No.: US 2019/0207472 A1
(43) Pub. Date: Jul. 4, 2019

(54) ELECTRIC ACTUATOR

(71) Applicant: NIDEC TOSOK CORPORATION, Kanagawa (JP)

(72) Inventors: Yutaka UEMATSU, Kanagawa (JP); Shun KATO, Kanagawa (JP); Ryunosuke OIKAWA, Kanagawa (JP); Yuzo AKASAKA, Kanagawa (JP); Kazumi SHINKAI, Kanagawa (JP)

(73) Assignee: NIDEC TOSOK CORPORATION, Kanagawa (JP)

(21) Appl. No.: 16/234,514

(22) Filed: Dec. 27, 2018

(30) Foreign Application Priority Data
Dec. 28, 2017 (JP) 2017-253679

(51) Int. Cl. H02K 7/116; H02K 5/08; H02K 5/173; H02K 5/22; H02K 7/08; H02K 11/215; H02K 21/14; F16H 61/00; F16H 61/32

(52) U.S. Cl. CPC H02K 7/116; H02K 5/08; H02K 5/1732; H02K 5/225; H02K 7/083; F16H 19/001; H02K 21/14; F16H 61/0006; F16H 61/32; H02K 2211/03; H02K 11/215

(57) ABSTRACT

An electric actuator includes: a motor unit that has a motor shaft and a rotor main body; a speed reducer; a circuit board; an output section; a detection target section; a motor unit sensor; a preload member; and a support section. The motor shaft passes through a through-hole and penetrates through the circuit board in an axial direction. The detection target section is attached to a portion, which protrudes to one side in the axial direction beyond the circuit board, of the motor shaft. The detection target section faces a surface of the circuit board via a gap. The motor unit sensor is fixed to a portion, which faces the detection target section via a gap, of a surface of the circuit board. The preload member applies a preload to the motor shaft toward the other side in the axial direction and presses the motor shaft against the support section.

### CROSS REFERENCE TO RELATED APPLICATIONS

The application claims priority under 35 U.S.C. § 119 to Japanese Patent Application No. 2017-253679 filed on Dec. 28, 2017, and the entire content of which is incorporated herein by reference and made a part of this specification.

### BACKGROUND

### Technical Field

The disclosure relates to an electric actuator.

### Description of Related Art

An electric actuator including a motor unit, a speed reducer that is coupled to the motor unit, an output section to which rotation of the motor unit is delivered via the speed reducer, a detection target section that is attached to a motor shaft of the motor unit, and a motor unit sensor that detects a position of the detection target section and detects rotation of the motor shaft is known. Such an electric actuator is provided with a magnet that serves as the detection target section and a hall IC that serves as the motor unit sensor.

If oscillation is applied to the electric actuator as described above, the motor shaft may move in an axial direction in some cases. In such cases, the detection target section attached to the motor shaft is brought into contact with the motor unit sensor, and the detection target section or the motor unit sensor or both the detection target section and the motor unit sensor may be damaged in some cases.

In view of the aforementioned circumstances, the disclosure enables suppression of damage to the detection target section and the motor unit sensor.

### SUMMARY

According to an aspect of the disclosure, an electric actuator includes: a motor unit that has a motor shaft extending in an axial direction and a rotor main body fixed to the motor shaft; a speed reducer that is fixed to the motor shaft; a circuit board that is electrically connected to the motor unit and is arranged on one side in an axial direction beyond the rotor main body; an output section that has an output shaft to which rotation of the motor shaft is delivered via the speed reducer; a detection target section that is attached to the motor shaft; a motor unit sensor that detects a position of the detection target section and detects rotation of the motor shaft; a preload member that applies a preload to the motor shaft; and a support section that supports the motor shaft from the other side in the axial direction. The motor unit has a first bearing that rotatably supports the motor shaft. The circuit board has a through-hole that penetrates the circuit board in the axial direction. The motor shaft passes through a through-hole and penetrates through the circuit board in the axial direction. The detection target section is attached to a portion, which protrudes to one side in the axial direction beyond the circuit board, of the motor shaft. The detection target section faces a surface on one side in the axial direction of the circuit board in the axial direction via a gap. The motor unit sensor is fixed to a portion, which faces the detection target section in the axial direction via a gap, of a surface on one side in the axial direction of the circuit board. The preload member applies a preload to the motor shaft toward the other side in the axial direction and presses the motor shaft against the support section.

According to an aspect of the disclosure, the electric actuator that has a structure that enables suppression of damage to the detection target section and the motor unit sensor is provided.

The above and other elements, features, steps, characteristics and advantages of the disclosure will become more apparent from the following detailed description of the embodiments with reference to the attached drawings.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a sectional view illustrating an electric actuator according to an embodiment.

FIG. 2 is a sectional view illustrating a part of the electric actuator according to the embodiment and is a partially enlarged view of FIG. 1.

FIG. 3 is a perspective view illustrating a motor shaft and a magnet holder according to the embodiment.

FIG. 4 is a perspective view of a sensor magnet for a motor unit and the magnet holder according to the embodiment.

FIG. 5 is a perspective view illustrating a metal member according to the embodiment.

### DESCRIPTION OF THE EMBODIMENTS

In the respective drawings, a Z-axis direction is an upward/downward direction in which the positive side is an upper side and the negative side is a lower side. An axial direction of a central axis J1 that is a virtual axis that is appropriately represented in the respective drawings is parallel to the Z axial direction, that is, the upward/downward direction. In the following description, the direction that is parallel to the axial direction of the central axis J1 will simply be referred to as an “axial direction Z.” Also, a diameter direction about the central axis J1 will simply be referred to as a “radial direction” while a circumferential direction about the central axis J1 will simply be referred to as a “circumferential direction” unless particularly stated otherwise. In the embodiment, the upper side corresponds to one side in the axial direction while the lower side corresponds to the other side in the axial direction. Note that the upper side and the lower side are names for simply describing a relative positional relationship, and an actual arrangement relationship or the like may be an arrangement relationship or the like other than the arrangement relationship or the like represented by these names.

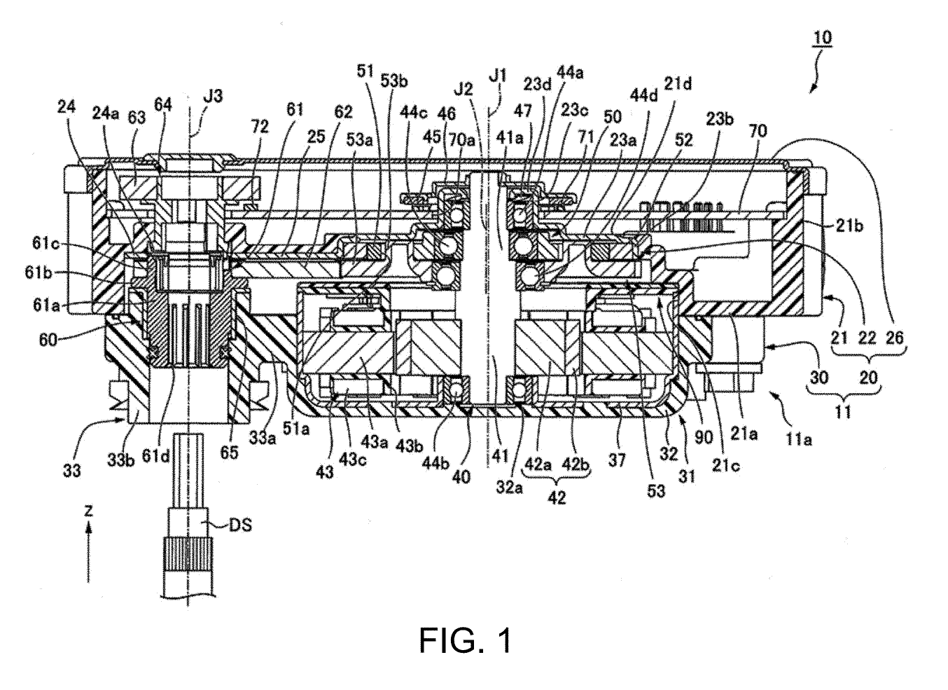

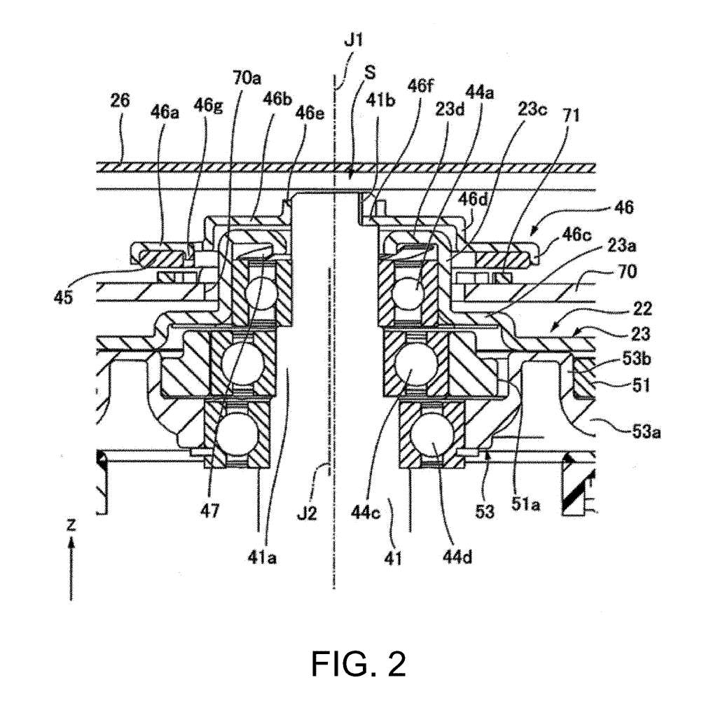

An electric actuator 10 according to the embodiment illustrated in FIGS. 1 and 2 is attached to a vehicle. More specifically, the electric actuator 10 is mounted on a shift-by-wire-scheme actuator device that drives on the basis of a shift operation of a driver of a vehicle. As illustrated in FIG. 1, the electric actuator 10 includes a motor unit 40, a speed reducer 50, an output section 60, a circuit board 70, a motor unit sensor 71, an output section sensor 72, a housing 11, a busbar holder 90, and a busbar which is not illustrated in the drawing.

The motor unit 40 has a motor shaft 41, a first bearing 44a, a second bearing 44b, a third bearing 44c, a fourth bearing 44d, a rotor main body 42, a stator 43, a sensor magnet 45 for motor unit, and a magnet holder 46. In the embodiment, the sensor magnet 45 for a motor unit corresponds to the detection target section while the magnet holder 46 corresponds to the detection target section holder.

The motor shaft 41 extends in the axial direction Z. The first bearing 44a, the second bearing 44b, the third bearing 44c, and the fourth bearing 44d support the motor shaft 41 such that the motor shaft 41 can rotate about the central axis J1. In the embodiment, the first bearing 44a, the second bearing 44b, the third bearing 44c, and the fourth bearing 44d are ball bearings, for example.

An eccentric shaft section 41a that is a portion, which is supported by the third bearing 44c, of the motor shaft 41 has a cylindrical shape that extends about an eccentric shaft J2 that is parallel to the center axis J1 and is eccentric to the central axis J1. A portion other than the eccentric shaft section 41a of the motor shaft 41 has a cylindrical shape that extends about the central axis J1.

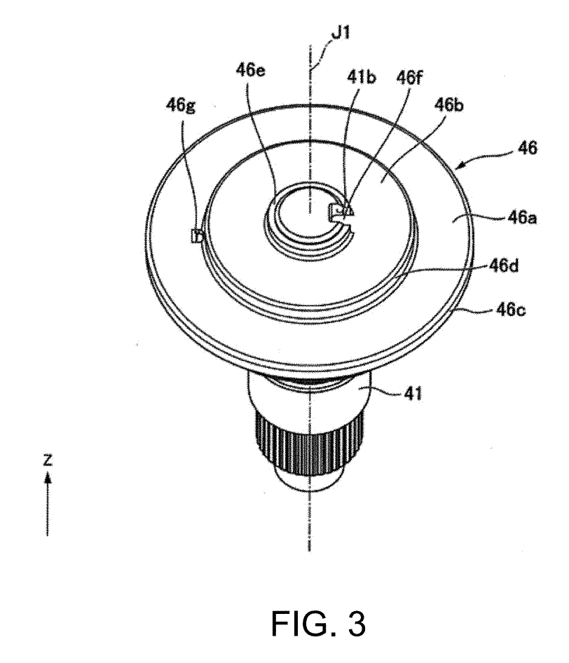

As illustrated in FIGS. 2 and 3, the motor shaft 41 has a positioning concave section 41b. The positioning concave section 41b is recessed inward in the radial direction from an outer circumferential surface at an upper end of the motor shaft 41. The positioning concave section 41b opens on the upper side.

As illustrated in FIG. 1, the rotor main body 42 is fixed to the motor shaft 41. More specifically, the rotor main body 42 is fixed to a portion on the lower side of the motor shaft 41. The rotor main body 42 has a rotor core 42a and a rotor magnet 42b. The rotor core 42a is fixed to an outer circumferential surface, which is at a portion below the eccentric shaft section 41a, of the motor shaft 41. The rotor magnet 42b is fixed to the outer circumferential surface of the rotor core 42a.

The stator 43 is arranged with a gap on the outer side in the radial direction of the rotor main body 42. The stator 43 has a ring shape that surrounds the outer side of the rotor main body 42 in the radial direction. The stator 43 has a stator core 43a, an insulator 43b, and a plurality of coils 43c. The coils 43c are attached to the stator core 43a via the insulator 43b.

As illustrated in FIG. 3, the magnet holder 46 has an annular shape about the central axis J1. The magnet holder 46 is made of a metal, for example. The magnet holder 46 according to the embodiment is a single member that is made by press-working a plate member made of a metal. The magnet holder 46 is attached to the motor shaft 41. More specifically, the magnet holder 46 is fixed to the outer circumferential surface at an upper end of the motor shaft 41. As illustrated in FIG. 2, the magnet holder 46 is arranged above the circuit board 70. The magnet holder 46 has a first annular plate section 46a, a second annular plate section 46b, a first cylindrical section 46c, a second cylindrical section 46d, a third cylindrical section 46e, a support target portion 46f, and a positioning protruding portion 46g.

As illustrated in FIG. 3, the first annular plate section 46a and a second annular plate section 46b have annular shapes about the central axis J1 and have plate surfaces with plate shapes that are perpendicular to the axial direction Z. As illustrated in FIG. 2, the first annular plate section 46a is arranged above a portion, which is on an outer side in the radial direction beyond a through-hole 70a that will be described later, of the circuit board 70. The second annular plate section 46b is arranged on the upper side and on the inner side in the radial direction from the first annular plate section 46a. The second annular plate section 46b is arranged on the upper side of the through-hole 70a. The outer diameter of the second annular plate section 46b is smaller than the outer diameter of the first annular plate section 46a.

As illustrated in FIG. 3, the first cylindrical section 46c has a cylindrical shape that protrudes downward from an outer edge portion in the radial direction of the first annular plate section 46a. The second cylindrical section 46d has a cylindrical shape that protrudes upward from an inner edge portion in the radial direction of the first annular plate section 46a. The outer edge portion in the radial direction of the second annular plate section 46b is connected to the upper end of the second cylindrical section 46d. That is, the second cylindrical section 46d connects the inner edge portion in the radial direction of the first annular plate section 46a to the outer edge portion in the radial direction of the second annular plate section 46b. The outer diameter and the inner diameter of the second cylindrical section 46d are smaller than the outer diameter and the inner diameter of the first cylindrical section 46c.

The third cylindrical section 46e has a tubular shape that protrudes upward from the inner edge portion in the radial direction of the second annular plate section 46b. The third cylindrical section 46e has a shape that is partially notched in a circumferential direction of the cylinder and has a C shape that opens in one radial direction when seen in the axial direction Z.

The upper end of the third cylindrical section 46e is an upper end of the magnet holder 46. The outer diameter and the inner diameter of the third cylindrical section 46e are smaller than the outer diameter and the inner diameter of the second cylindrical section 46d. The upper end of the motor shaft 41 is fitted into the inner side in the radial direction of the third cylindrical section 46e. The upper end of the motor shaft 41 protrudes slightly upward relative to the third cylindrical section 46e.

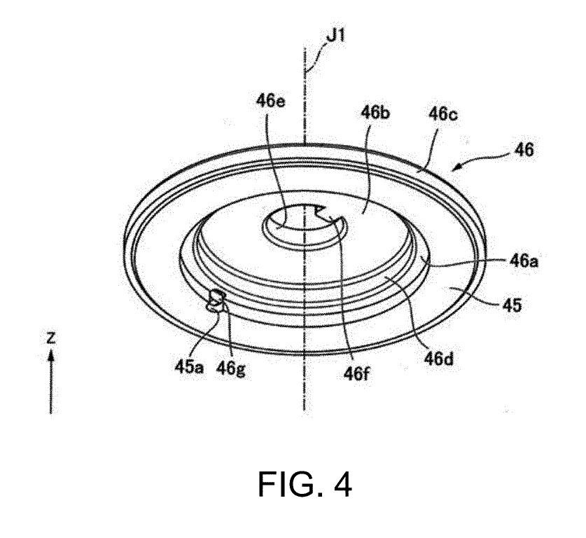

As illustrated in FIGS. 3 and 4, the support target portion 46f protrudes inward in the radial direction from the inner edge portion in the radial direction of the second annular plate section 46b. The support target portion 46f has a plate surface with a plate shape that is perpendicular to the axial direction Z. The support target portion 46f protrudes inward in the radial direction relative to the third cylindrical section 46e via a portion at which the C-shaped third cylindrical section 46e opens in the radial direction. The support target portion 46f has a substantially rectangular shape when seen in the axial direction Z. As illustrated in FIG. 3, the support target portion 46f is fitted into the positioning concave section 41b. In this manner, the support target portion 46f is hooked at side surfaces, which are located on both sides in the circumferential direction, of the inner surfaces of the positioning concave section 41b and can position the magnet holder 46 in the circumferential direction relative to the motor shaft 41.

As illustrated in FIG. 2, the support target portion 46f is in contact with and supported by a bottom surface, which is located on the lower side, of the inner surfaces of the positioning concave section 41b. In this manner, the support target portion 46f is supported by a portion of the motor shaft 41 from the lower side. Therefore, it is possible to position the magnet holder 46 in the axial direction Z relative to the motor shaft 41 and to prevent the magnet holder 46 from deviating downward relative to the motor shaft 41.

The positioning protruding portion 46g protrudes downward from the inner edge portion in the radial direction of the first annular plate section 46a. The positioning protruding portion 46g is made by a part of the first annular plate section 46a being cut and raised downward, for example. The lower end of the positioning protruding portion 46g is arranged above the lower end of the first cylindrical section 46c.

As illustrated in FIG. 4, the sensor magnet 45 for a motor unit has an annular plate shape about the central axis J1. The plate surface of the sensor magnet 45 for the motor unit is perpendicular to the axial direction Z. The sensor magnet 45 for the motor unit is fixed to the magnet holder 46. More specifically, the sensor magnet 45 for the motor unit is fitted on the inner side in the radial direction of the first cylindrical section 46c and is fixed to the lower surface of the first annular plate section 46a with an adhesive or the like. In this manner, the sensor magnet 45 for the motor unit is attached to the motor shaft 41 via the magnet holder 46.

As described above, the magnet holder 46 is arranged above the circuit board 70. In this manner, in the embodiment illustrated in FIG. 2, the sensor magnet 45 for the motor unit is attached to a portion, which protrudes above the circuit board 70, of the motor shaft 41. The sensor magnet 45 for the motor unit faces the upper surface of the circuit board 70 via a gap in the axial direction Z.

Note that, in the specification, “a portion, to which the detection target section is attached, of the motor shaft” refers to a portion, with which the detection target section is brought into contact, of the motor shaft in a case in which the detection target section is fixed directly to the motor shaft, or a portion, with which the detection target holder is brought into contact, of the motor shaft in a case in which the detection target section is fixed indirectly to the motor shaft via the detection target section holder. In the specification, since the sensor magnet 45 for the motor unit that serves as the detection target section is fixed to the motor shaft 41 via the magnet holder 46 that serves as the detection target section holder, the portion, to which the sensor magnet 45 for the motor unit is attached, of the motor shaft 41 is a portion, with which the magnet holder 46 is brought into contact, of the motor shaft 41.

In the specification, the portion, to which the sensor magnet 45 for the motor unit is attached, of the motor shaft 41 is arranged above the first bearing 44a. That is, the first bearing 44a supports the portion below the portion, to which the sensor magnet 45 for the motor unit is attached, of the motor shaft 41. Therefore, it is possible to reduce the size of the electric actuator 10 in the axial direction Z as compared with a case in which the first bearing 44a supports the portion above the portion, to which the sensor magnet 45 for the motor unit is attached, of the motor shaft 41.

As illustrated in FIG. 4, the sensor magnet 45 for the motor unit has a positioning concave section 45a. The positioning concave section 45a is recessed outward in the radial direction from the inner edge portion in the radial direction of the sensor magnet 45 for the motor unit. The positioning concave section 45a penetrates through the sensor magnet 45 for the motor unit in the axial direction Z. The positioning protruding portion 46g is fitted into the positioning concave section 45a. In this manner, the positioning protruding portion 46g is hooked at side surfaces, which are located on both sides in the circumferential direction, of the inner surfaces of the positioning concave section 45a, and it is possible to position the sensor magnet 45 for the motor unit in the circumferential direction relative to the magnet holder 46. Therefore, it is possible to position the sensor magnet 45 for the motor unit in the circumferential direction relative to the motor shaft 41 by the support target portion 46f and the positioning concave section 41b and by the positioning protruding portion 46g and the positioning concave section 45a.

As illustrated in FIG. 1, the speed reducer 50 is coupled to the upper side of the motor shaft 41. The speed reducer 50 is arranged on the upper side of the rotor main body 42 and the stator 43. The speed reducer 50 has an external gear 51, an internal gear 52, and an output gear 53.

Although not illustrated in the drawing, the external gear 51 has an annular plate shape that extends in the radial direction of the eccentric shaft J2 about the eccentric shaft J2 of the eccentric shaft section 41a. A gear section is provided on the outer surface in the radial direction of the external gear 51. The external gear 51 is connected to the motor shaft 41 via the third bearing 44c. In this manner, the speed reducer 50 is coupled to the motor shaft 41. The external gear 51 is fitted into an outer wheel of the third bearing 44c from the outer side in the radial direction. In this manner, the third bearing 44c relatively rotatably couples the motor shaft 41 and the external gear 51 about the eccentric shaft J2.

The external gear 51 has a plurality of holes 51a that allow the external gear 51 to penetrate therethrough in the axial direction Z. Although not illustrated in the drawing, the plurality of holes 51a are arranged at equal intervals all around the circumferential direction about the eccentric shaft J2. The shape of each hole 51a in the axial direction Z is a circular shape.

The internal gear 52 is fixed to the circuit board case 20 around the outer side in the radial direction of the external gear 51 and is meshed with the external gear 51. The internal gear 52 is held by a metal member 22 of the housing 11, which will be described later. The internal gear 52 has an annular shape about the central axis J1. A gear section is provided at the inner circumferential surface of the internal gear 52. The gear section of the internal gear 52 is meshed with the gear section of the external gear 51.

The output gear 53 has an output gear main body 53a and a plurality of pins 53b. The output gear main body 53a is arranged on the lower side of the external gear 51 and the internal gear 52. The output gear main body 53a has an annular plate shape that extends in the radial direction about the central axis J1. A gear section is provided at an outer surface in the radial direction of the output gear main body 53a. The output gear main body 53a is connected to the motor shaft 41 via the fourth bearing 44d.

The plurality of pins 53b have cylindrical shapes that protrude upward from the upper surface of the output gear main body 53a. Although not illustrated in the drawing, the plurality of pins 53b are arranged at equal intervals all around the circumferential direction. The outer diameter of each pin 53b is smaller than the inner diameter of each hole 51a. The plurality of pins 53b are caused to pass through the plurality of respective holes 51a from the lower side. The outer circumferential surfaces of the pins 53b are inscribed by the inner circumferential surfaces of the holes 51a. The inner circumferential surfaces of the holes 51a support the external gear 51 via the pins 53b such that the external gear 51 can slide about the central axis J1.

The output section 60 is a portion that outputs drive force of the electric actuator 10. The output section 60 is arranged on the outer side in the radial direction of the motor unit 40. The output section 60 has an output shaft 61, a driving gear 62, a sensor magnet 63 for the output section, and a magnet holder 64.

The output shaft 61 has a tubular shape that extends in the axial direction Z of the motor shaft 41. In this manner, since the output shaft 61 extends in the same direction as the motor shaft 41, it is possible to simplify the structure of the speed reducer 50 that delivers the rotation of the motor shaft 41 to the output shaft 61. In the embodiment, the output shaft 61 has a cylindrical shape about an output central axis J3 that is a virtual axis. The output central axis J3 is arranged such that the output central axis J3 is parallel to the central axis J1 and is away from the central axis J1 in the radial direction. That is, the motor shaft 41 and the output shaft 61 are arranged away from each other in the radial direction of the motor shaft 41.

The output shaft 61 has openings 61d that open on the lower side. In the embodiment, the output shaft 61 opens on both sides in the axial direction. The output shaft 61 has a spline groove at a lower portion of the inner circumferential surface. The output shaft 61 has a cylindrical output shaft main body 61a and a flange section 61b that protrudes outward in the radial direction of the output central axis J3 from the output shaft main body 61a. The output shaft 61 is arranged at a position at which the output shaft 61 overlaps with the rotor main body 42 in the radial direction of the motor shaft 41. The lower end of the output shaft 61, that is, the opening 61d, is arranged above the lower end of the motor unit 40. In the embodiment, the lower end of the motor unit 40 is a lower end of the motor shaft 41.

A driven shaft DS is inserted into and coupled to the output shaft 61 via the opening 61d from the lower side. More specifically, the output shaft 61 and the driven shaft DS are coupled to each other by the spline portion provided at the outer circumferential surface of the driven shaft DS being fitted into the spline groove provided at the inner circumferential surface of the output shaft 61. Drive force of the electric actuator 10 is delivered to the driven shaft DS via the output shaft 61. In this manner, the electric actuator 10 causes the driven shaft DS to rotate about the output central axis J3.

As described above, the side on which the opening 61d with the driven shaft DS inserted thereinto opens is the same side on which the motor unit 40 is arranged relative to the speed reducer 50 in the axial direction Z. Therefore, the motor unit 40 can be arranged on the side of an attachment target body to which the electric actuator 10 is attached. In this manner, it is possible to utilize a space outside the driven shaft DS as a space in which the motor unit 40 is arranged in the radial direction of the driven shaft DS. Therefore, it is possible to attach the electric actuator 10 to the attachment target body more closely. Therefore, the electric actuator 10 capable of reducing the attachment height when attached to the attachment target body is obtained according to the embodiment. The attachment target body in the embodiment is a vehicle.

In addition, according to the embodiment, an orientation in which the motor shaft 41 extends from the motor unit 40 toward the speed reducer 50 is an upward orientation, which is opposite to the orientation in which the opening 61d of the output shaft 61 opens. Therefore, it is possible to set the orientation in which the output shaft 61 extends from the speed reducer 50 to be opposite to the orientation in which the motor shaft 41 extends from the motor unit 40 toward the speed reducer 50. In this manner, it is possible to arrange the motor shaft 41 and the output shaft 61 such that the motor shaft 41 and the output shaft 61 overlap with each other in the radial direction of the motor shaft 41 and to reduce the size of the electric actuator 10 in the axial direction Z. Also, since the output shaft 61 overlaps the rotor main body 42 in the radial direction of the motor shaft 41, it is possible to further reduce the size of the electric actuator 10 in the axial direction Z. In this manner, it becomes easier to reduce the attachment height of the electric actuator 10 when attached to the attachment target body.

Also, according to the embodiment, the lower end of the motor unit 40 is arranged below the opening 61d. Therefore, it is possible to arrange the motor unit 40 at a closer position to the attachment target body. In this manner, it becomes easier to further reduce the attachment height of the electric actuator 10 when attached to the attachment target body.

The driving gear 62 is fixed to the output shaft 61 and is meshed with the output gear 53. In the embodiment, the driving gear 62 is fixed to a portion, which is upper than the flange section 61b, of the outer circumferential surface of the output shaft main body 61a. The driving gear 62 is brought into contact with the upper surface of the flange section 61b. Although not illustrated in the drawing, the driving gear 62 is a fan-shaped gear that extends from the output shaft 61 toward the output gear 53 and has a width increasing toward the output gear 53. A gear section is provided at an end of the driving gear 62 on the side of the output gear 53. The gear section of the driving gear 62 is meshed with the gear section of the output gear 53.

The magnet holder 64 is a substantially cylindrical member that extends in the axial direction Z about the output central axis J3. The magnet holder 64 opens on both sides in the axial direction. The magnet holder 64 is arranged on the upper side of the output shaft 61 and on the outer side in the radial direction of the speed reducer 50. The magnet holder 64 penetrates through the circuit board 70 in the axial direction Z. The inner portion of the magnet holder 64 is coupled to the inner portion of the output shaft 61. An upper end of the driven shaft DS inserted into the output shaft 61 is press-fitted into the magnet holder 64. In this manner, the magnet holder 64 is fixed to the driven shaft DS.

The sensor magnet 63 for the output section has an annular shape about the output central axis J3. The sensor magnet 63 for the output section is fixed to the outer circumferential surface at the upper end of the magnet holder 64. The sensor magnet 63 for the output section is fixed to the driven shaft DS via the magnet holder 64 by the magnet holder 64 being fixed to the driven shaft DS. The sensor magnet 63 for the output section faces the upper surface of the circuit board 70 via a gap.

If the motor shaft 41 is caused to rotate about the central axis J1, the eccentric shaft section 41a revolves in the circumferential direction about the central axis J1. The revolution of the eccentric shaft section 41a is delivered to the external gear 51 via the third bearing 44c, and the external gear 51 slides while positions at which the outer circumferential surfaces of the pins 53b are inscribed in the inner circumferential surfaces of the holes 51a change. In this manner, the position at which the gear section of the external gear 51 and the gear section of the internal gear 52 are meshed with each other changes in the circumferential direction. Therefore, rotation force of the motor shaft 41 is delivered to the internal gear 52 via the external gear 51.

Here, the internal gear 52 does not rotate since the internal gear 52 is fixed in the embodiment. Therefore, the external gear 51 rotates about the eccentric shaft J2 using counterforce of the rotation force delivered to the internal gear 52. At this time, the orientation in which the external gear 51 rotates is opposite to the orientation in which the motor shaft 41 rotates. The rotation of the external gear 51 about the eccentric shaft J2 is delivered to the output gear 53 via the holes 51a and the pins 53b. In this manner, the output gear 53 rotates about the central axis J1. The rotation of the motor shaft 41 is decelerated and is delivered to the output gear 53.

If the output gear 53 rotates, the driving gear 62 meshed with the output gear 53 rotates about the output central axis J3. In this manner, the output shaft 61 fixed to the driving gear 62 rotates about the output central axis J3. In this manner, the rotation of the motor shaft 41 is delivered to the output shaft 61 via the speed reducer 50.

The circuit board 70 is arranged above the rotor main body 42. The circuit board 70 is arranged on the upper side of the speed reducer 50. The circuit board 70 has a plate surface with a plate shape that is perpendicular to the axial direction Z. The circuit board 70 has a through-hole 70a that penetrates through the circuit board 70 in the axial direction Z. The motor shaft 41 is caused to pass through the through-hole 70a. In this manner, the motor shaft 41 penetrates through the circuit board 70 in the axial direction. The circuit board 70 is electrically connected to the stator 43 via a busbar, which is not illustrated in the drawing. That is, the circuit board 70 is electrically connected to the motor unit 40.

The motor unit sensor 71 is fixed to the upper surface of the circuit board 70. More specifically, the motor unit sensor 71 is fixed to a portion, which faces the sensor magnet 45 for the motor unit in the axial direction Z via a gap, of the upper surface of the circuit board 70.

The motor unit sensor 71 is a magnetic sensor that detects a magnetic field of the sensor magnet 45 for the motor unit. The motor unit sensor 71 is a hall element, for example. Although not illustrated in the drawing, three motor unit sensors 71 are provided in the circumferential direction, for example. The motor unit sensors 71 detect the rotation position of the sensor magnet 45 for the motor unit by detecting the magnetic field of the sensor magnet 45 for the motor unit, thereby detecting the rotation of the motor shaft 41.

In the embodiment, the speed reducer 50 is coupled to the upper side of the motor shaft 41, and the circuit board 70 is arranged above the rotor main body 42 and on the upper side of the speed reducer 50. Therefore, the speed reducer 50 is arranged between the circuit board 70 and the rotor main body 42 in the axial direction Z. In this manner, it is possible to arrange the motor unit sensor 71 fixed to the circuit board 70 away from the rotor main body 42 and the stator 43. Therefore, it is possible to reduce influences of the magnetic field generated by the rotor main body 42 and the stator 43 and acting on the motor unit sensor 71 and to improve detection accuracy of the motor unit sensor 71.

The output section sensors 72 are fixed to the upper surface of the circuit board 70. More specifically, the output section sensors 72 are fixed to a portion, which faces the sensor magnet 63 for the output section in the axial direction Z via a gap, of the upper surface of the circuit board 70. The output section sensors 72 are magnetic sensors that detect a magnetic field of the sensor magnet 63 for the output section. The output section sensors 72 are hall elements, for example. Although not illustrated in the drawing, three output section sensors 72 are provided in the circumferential direction about the output center axis J3, for example. The output section sensors 72 detect a rotation position of the sensor magnet 63 for the output section by detecting the magnetic field of the sensor magnet 63 for the output section, thereby detecting the rotation of the driven shaft DS.

According to the embodiment, it is possible to arrange the driving gear 62 that delivers rotation drive force to the output gear 53 at a position closer to the sensor magnet 63 for the output section with the configuration in which the speed reducer 50 is arranged on the side of the circuit board 70 beyond the motor unit 40. Therefore, it is possible to reduce the distance from a portion, to which rotation drive force is delivered, of the output gear 53 to a portion to which the sensor magnet 63 for the output section is fixed in the axial direction Z and to prevent axial deviation of the driven shaft DS from deviating from the axis at the portion to which the sensor magnet 63 for the output section is fixed. In this manner, it is possible to improve detection accuracy of the rotation of the driven shaft DS using the output section sensor 72.

The housing 11 accommodates the motor unit 40, the speed reducer 50, the output section 60, the circuit board 70, the motor unit sensor 71, the output section sensor 72, the busbar holder 90, and the busbar, which is not illustrated in the drawing. The housing 11 has a motor case 30 and a circuit board case 20. The motor case 30 opens to the upper side. The motor case 30 has a motor case main body 31 and a stator fixing member 37. The circuit board case 20 has a substantially rectangular parallelepiped box shape. The circuit board case 20 is attached to the upper side of the motor case 30 and blocks the opening of the motor case 30. The circuit board case 20 accommodates the circuit board 70. The circuit board case 20 has a circuit board case main body 21, a metal member 22, and a circuit board case cover 26.

The circuit board case main body 21 and the motor case main body 31 are made of resin. In the embodiment, the housing main body 11a is formed with the circuit board case main body 21 and the motor case main body 31. That is, the housing 11 has the housing main body 11a made of resin.

The circuit board case main body 21 has a box shape opening to the upper side. The circuit board case main body 21 has a bottom wall 21a and a side wall 21b. The bottom wall 21a extends along a plane that is perpendicular to the axial direction Z. The bottom wall 21a extends outwardly in the radial direction beyond the motor case main body 31 when seen in the axial direction Z. The bottom wall 21a blocks the upper opening of the motor case 30. The bottom wall 21a covers the upper side of the stator 43.

The bottom wall 21a has a concave section 21c that is recessed upwardly from the lower surface of the bottom wall 21a. The bottom wall 21a has a central through-hole 21d that penetrates through the bottom wall 21a in the axial direction Z. The central through-hole 21d penetrates through the bottom wall 21a from the bottom surface of the concave section 21c to the upper surface of the bottom wall 21a. The central through-hole 21d has a circular shape about the central axis J1 when seen in the axial direction Z. The motor shaft 41 is caused to pass through the central through-hole 21d.

The side wall 21b has a rectangular cylindrical shape that protrudes upwardly from an outer edge portion of the bottom wall 21a. The circuit board 70 is accommodated inside the side wall 21b. That is, the circuit board case 20 accommodates the circuit board 70 above the bottom wall 21a. The side wall 21b opens on the upper side. The upper opening of the side wall 21b, that is, the upper opening of the circuit board case 20 is blocked with the circuit board case cover 26. The circuit board case cover 26 is made of metal, for example.

The metal member 22 is made of metal. The metal member 22 is held by the circuit board case main body 21. That is, the metal member 22 is held by the housing main body 11a. The metal member 22 is accommodated and held in the concave section 21c. A part of the metal member 22 is embedded in the housing main body 11a in the embodiment. Therefore, it is possible to create a part or entirety of the housing main body 11a using insert molding in which the metal member 22 is inserted into a mold and resin is poured into the mold. Therefore, it is easy to produce the housing 11. In the embodiment, the circuit board case main body 21 in the housing main body 11a is created by insert molding in which the metal member 22 is inserted into a mold and resin is poured into the mold.

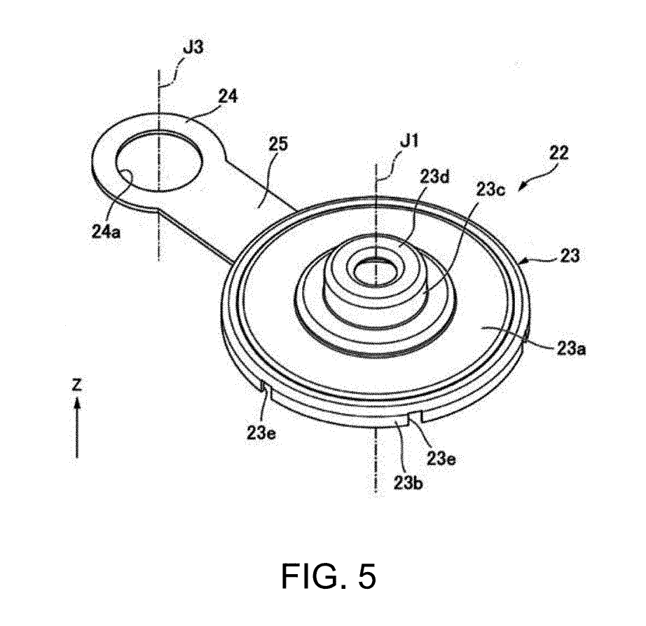

As illustrated in FIG. 5, the metal member 22 has a bearing holding section 23, an arm section 25, and an output shaft support section 24. The bearing holding section 23 has an annular plate section 23a, an outer cylindrical section 23b, an inner cylindrical section 23c, and a top plate section 23d. The annular plate section 23a has an annular plate shape about the central axis J1. The plate surface of the annular plate section 23a is perpendicular to the axial direction Z.

The outer cylindrical section 23b has a cylindrical shape that protrudes downward from the outer circumferential edge portion of the annular plate section 23a. The outer cylindrical section 23b has a plurality of slits 23e that penetrate through a wall portion of the outer cylindrical section 23b in the radial direction. The plurality of slits 23e are arranged at equal intervals all around the circumferential direction. The slits 23e open to the lower side.

As illustrated in FIG. 1, the internal gear 52 is held on the inner side in the radial direction of the outer cylindrical section 23b. In this manner, the speed reducer 50 is held at the lower surface of the bottom wall 21a via the metal member 22. Although not illustrated in the drawing, a plurality of protruding portions that protrude outward in the radial direction are provided at the outer circumferential surface of the internal gear 52, and the protruding portions are inserted into the respective slits 23e. In this manner, the protruding portions are hooked at the inner surfaces of the slits 23e, and it is possible to prevent the internal gear 52 from moving in the circumferential direction relative to the metal member 22. The outer cylindrical section 23b is embedded on the inner side in the radial direction of the central through-hole 21d and held therein.

The inner cylindrical section 23c has a cylindrical shape that protrudes upward from the inner circumferential edge of the annular plate section 23a. The first bearing 44a is held on the inner side in the radial direction of the inner cylindrical section 23c. In this manner, the bearing holding section 23 holds the first bearing 44a. The inner cylindrical section 23c protrudes above the bottom wall 21a. The inner cylindrical section 23c is arranged on the inner side in the radial direction of the side wall 21b. The inner cylindrical section 23c penetrates through the circuit board 70 in the axial direction Z via the through-hole 70a and protrudes above the circuit board 70.

In this manner, at least a portion of the first bearing 44a that is held at the inner cylindrical section 23c is inserted into the through-hole 70a. Therefore, it is possible to support the motor shaft 41 at a position that is closer to the portion, to which the sensor magnet 45 for the motor unit is attached, of the motor shaft 41 by the first bearing 44a. In this manner, it is possible to prevent the axis at the portion, to which the sensor magnet 45 for the motor unit is attached, of the motor shaft 41 from deviating and to prevent the position of the sensor magnet 45 for the motor unit from deviating. Therefore, it is possible to prevent detection accuracy of the rotation of the motor shaft 41 using the motor unit sensor 71 from being degraded. Also, since it is possible to arrange the first bearing 44a and the circuit board 70 such that the first bearing 44a and the circuit board 70 overlap with each other when seen in the radial direction, it becomes easy to reduce the size of the electric actuator 10 in the axial direction Z.

“The bearing holding section holds the first bearing” in the specification means that it is only necessary for the bearing holding section to be able to position the first bearing in the radial direction, and it is not necessary for the first bearing to be fixed to the bearing holding section. In the embodiment, the first bearing 44a is positioned in the radial direction by being fitted into the inner cylindrical section 23c. The first bearing 44a is not fixed to the inner cylindrical section 23c.

The top plate section 23d protrudes inward in the radial direction from the upper end of the inner cylindrical section 23c. The top plate section 23d has an annular shape about the central axis J1 and has the plate surface with a plate shape that is perpendicular to the axial direction Z. The upper end of the motor shaft 41 is caused to pass through the inner side of the top plate section 23d. The inner circumferential edge of the top plate section 23d is curved on the lower side. The top plate section 23d covers the upper side of the first bearing 44a.

As illustrated in FIG. 2, a preload member 47 is arranged between the top plate section 23d and the first bearing 44a in the axial direction Z. That is, the electric actuator 10 includes the preload member 47. The preload member 47 is an annular wave washer extending in the circumferential direction. The preload member 47 is in contact with the lower surface of the top plate section 23d and the upper end of the outer wheel of the first bearing 44a. The preload member 47 applies a downward preload to the outer wheel of the first bearing 44a. In this manner, the preload member 47 applies a downward preload to the first bearing 44a and applies a downward preload to the motor shaft 41 via the first bearing 44a.

The motor shaft 41 that receives the downward preload by the preload member 47 is supported from the lower side by the second bearing 44b illustrated in FIG. 1. More specifically, the second bearing 44b is supported at the outer wheel thereof from the lower side by the annular protruding portion 32a of the motor accommodating section 32 and supports the motor shaft 41 from the lower side with the inner wheel fixed to the outer circumferential surface of the motor shaft 41. The second bearing 44b according to the embodiment corresponds to the support section that supports the motor shaft 41 from the lower side. That is, the electric actuator 10 includes the second bearing 44b that serves as a support section.

It is possible to prevent the motor shaft 41 from moving to the lower side even if the preload member 47 applies the downward preload to the motor shaft 41 by the second bearing 44b being provided as the support section. The preload member 47 applies the downward preload to the motor shaft 41 and presses the motor shaft 41 against the second bearing 44b that serves as the support section. In this manner, it is possible to maintain the position of the motor shaft 41 in the axial direction Z at the lowermost position in a state in which no oscillation is applied to the electric actuator 10. Therefore, it is possible to prevent the motor shaft 41 from moving downward and to change the orientation in which the motor shaft 41 moves to the upward orientation even in a case in which oscillation is applied to the electric actuator 10 and the motor shaft 41 moves in the axial direction Z.

In addition, the sensor magnet 45 for the motor unit faces the upper surface of the circuit board 70 in the axial direction Z via a gap, and the motor unit sensor 71 is fixed to a portion, which faces the sensor magnet 45 for the motor unit in the axial direction Z via a gap, of the upper surface of the circuit board 70. That is, the sensor magnet 45 for the motor unit that is attached to the motor shaft 41 is arranged on the upper side of the motor unit sensor 71. In this manner, since it is possible to change the orientation in which the motor shaft 41 moves when oscillation is applied to the electric actuator 10 to the upward orientation, the motor shaft 41 moves in an orientation in which the sensor magnet 45 for the motor unit is away from the motor unit sensor 71 even if the motor shaft 41 moves. Therefore, it is possible to prevent the sensor magnet 45 for the motor unit from being brought into contact with the motor unit sensor 71. Note that the preload member 47 is compressed and is elastically deformed in the axial direction Z when the motor shaft 41 moves upward.

As described above, according to the embodiment, it is possible to prevent the sensor magnet 45 for the motor unit from being brought into contact with the motor unit sensor 71 by setting the orientation in which the preload member 47 applies the preload to the motor shaft 41 to the orientation from the sensor magnet 45 for the motor unit toward the motor unit sensor 71. In this manner, the electric actuator 10 that has a structure capable of preventing the sensor magnet 45 for the motor unit and the motor unit sensor 71 from being damaged.

Also, a case in which the sensor magnet for the motor unit is arranged below the circuit board and the motor unit sensor is attached to the lower surface of the circuit board, for example, will be considered. In this case, it is only necessary to set the orientation in which the motor shaft moves when oscillation is applied to the electric actuator to the downward orientation by applying the upward preload to the motor shaft with the preload member in order to prevent the sensor magnet for the motor unit and the motor unit sensor from being bright into contact with each other as described above. However, in this case, the sensor magnet for the motor unit or the magnet holder that holds the sensor magnet for the motor unit may be brought into contact with the motor case or the like that accommodates the motor unit when the motor shaft moves downward. In this manner, the position of the sensor magnet for the motor unit relative to the motor shaft may deviate upward. In this state, there is a concern that if the motor shaft returns to the original position, the sensor magnet for the motor unit may be brought into contact with the motor unit sensor positioned on the upper side.

Meanwhile, according to the embodiment, the motor shaft 41 penetrates the circuit board 70 arranged above the rotor main body 42 in the axial direction Z, and the sensor magnet 45 for the motor unit is attached to the portion, which protrudes upward beyond the circuit board 70, of the motor shaft 41. Therefore, the orientation in which the motor shaft 41 moves becomes the orientation away from the motor case 30 that accommodates the motor unit 40 when oscillation is applied to the electric actuator 10. Therefore, it is possible to prevent the sensor magnet 45 for the motor unit and the magnet holder 46 from being brought into contact with the motor case 30 and to prevent the position of the sensor magnet 45 for the motor unit from deviating relative to the motor shaft 41 when the motor shaft 41 moves. In this manner, it is possible to prevent the sensor magnet 45 for the motor unit and the motor unit sensor 71 from being brought into contact with each other when the position of the motor shaft 41 in the axial direction Z returns to the original position. Therefore, it is possible to further prevent the sensor magnet 45 for the motor unit and the motor unit sensor 71 from being damaged.

In the embodiment, a gap S is provided between the upper end of the motor shaft 41, the sensor magnet 45 for the motor unit, and the magnet holder 46 and the circuit board case cover 26 in the axial direction Z as illustrated in FIG. 2. The gap S is greater than the maximum amount of movement of the motor shaft 41 that moves upward when oscillation is applied to the electric actuator 10. Therefore, it is possible to prevent the upper end of the motor shaft 41, the sensor magnet 45 for the motor unit, and the magnet holder 46 from being brought into contact with the circuit board case cover 26 even in the case in which the motor shaft 41 moves upward.

Also, according to the embodiment, it is possible to improve precision in holding the motor shaft 41 with the first bearing 44a by the preload being applied to the first bearing 44a with the preload member 47 since the first bearing 44a is a ball bearing. In addition, the preload of the preload member 47 is delivered to the second bearing 44b, the third bearing 44c, and the fourth bearing 44d that are ball bearings via the motor shaft 41. Therefore, it is possible to improve precision in holding the motor shaft 41 with the respective ball bearings. Also, it is possible to apply the preload to the first bearing 44a and also to apply the preload to the motor shaft 41 with a single preload member 47 and to thereby prevent the number of components of the electric actuator 10 from increasing.

In addition, according to the embodiment, the magnet holder 46 that holds the sensor magnet 45 for the motor unit has a support target portion 46f that is supported from the lower side at a portion of the motor shaft 41. Therefore, it is possible to prevent the magnet holder 46 from moving downward relative to the motor shaft 41 with the support target portion 46f even in a case in which the magnet holder 46 is brought into contact with the housing 11 when the motor shaft 41 moves upward. Therefore, it is possible to prevent the sensor magnet 45 for the motor unit from moving downward relative to the motor shaft 41 and to prevent the sensor magnet for the motor unit 45 from being brought into contact with the motor unit sensor 71 when the position of the motor shaft 41 in the axial direction Z returns to the original position.

In addition, damage such as chipping of a portion of the detection target section tends to occur when the detection target section is brought into contact with other members in a case in which the detection target section is a magnet as in the embodiment. Therefore, the effect that it is possible to prevent the sensor magnet for the motor unit 45 that serves as the detection target section as described above from being damaged can be particularly effectively obtained in the case in which the detection target section is a magnet as in the embodiment.

Also, according to the embodiment, the preload member 47 is a wave washer. Therefore, it is possible to reduce the size of the electric actuator 10 in the axial direction Z as compared with a case in which the preload member is a coil spring or the like, for example.

As illustrated in FIG. 1, the arm section 25 extends outward in the radial direction of the motor shaft 41 from the bearing holding section 23. As illustrated in FIG. 5, the arm section 25 has a plate surface with a plate shape that is perpendicular to the axial direction Z. The arm section 25 has a rectangular shape when seen in the axial direction Z. The arm section 25 couples the bearing holding section 23 and the output shaft support section 24. In this manner, the sizes of the bearing holding section 23, the output shaft support section 24, and the other portions in the metal member 22 is minimized, and the metal member 22 is easily reduced in size. Therefore, the manufacturing cost of the housing 11 is easily saved, and the weight of the housing 11 is easily reduced.

The output shaft support section 24 is coupled to the outer end in the radial direction of the arm section 25. The output shaft support section 24 has an annular shape about the output central axis J3 and has a plate surface with a pate shape that is perpendicular to the axial direction Z. In this manner, according to the embodiment, it is possible to easily create the output shaft support section 24 and the arm section 25 by press-working such as punching or bending a plate member made of metal or the like since the output shaft support section 24 and the arm section 25 have the plate shapes. The metal member 22 in the embodiment is a single member that is created by press-working a plate member made of metal.

The output shaft support section 24 has a through-hole 24a that penetrates through the output shaft support section 24 in the axial direction Z. As illustrated in FIG. 1, a fitting section 61c that is an upper end of the output shaft main body 61a is fitted into the through-hole 24a. That is, the output shaft 61 has the fitting section 61c that is fitted into the through-hole 24a. In this manner, the output shaft support section 24 supports the output shaft 61.

In this manner, according to the embodiment, it is possible to hold the first bearing 44a with the metal member 22 made of metal and to support the output shaft 61. In this manner, it is possible to precisely arrange the relative positions of the motor shaft 41 and the output shaft 61 supported with the first bearing 44a. In addition, since the housing main body 11a with which the metal member 22 is held is made of resin, it is possible to reduce the weight of the housing 11. As described above, according to the embodiment, it is possible to obtain the electric actuator 10 with a reduced weight and with a structure capable of preventing the precision of the relative positions of the motor shaft 41 and the output shaft 61 from being degraded. In addition, the metal member 22 has higher strength and heat resistance than resin since the metal member 22 is made of metal. Therefore, it is possible to prevent the metal member 22 from being significantly deformed or damaged and to prevent the motor shaft 41 and the output shaft 61 from deviating even in a case in which external force and heat are applied to the housing 11.

In addition, it is possible to easily cause the metal member 22 to support the output shaft 61 and to easily perform positioning by fitting the fitting section 61c into the through-hole 24a according to the embodiment. Therefore, it is possible to easily assemble the electric actuator 10.

The motor case main body 31 has a motor accommodating section 32 and an output section holding section 33. The motor accommodating section 32 has a tubular shape that has a bottom section and opens upward. The motor accommodating section 32 has a cylindrical shape about the central axis J1. The motor accommodating section 32 accommodates the motor unit 40. That is, the motor case main body 31 accommodates the motor unit 40.

Note that “the motor case main body accommodates the motor unit” in the specification means that it is only necessary that only a portion of the motor unit be accommodated in the motor case main body and the other portion of the motor unit may protrude to the outside of the motor case main body. In the embodiment, the motor case main body 31, that is, the motor accommodating section 32 accommodates the lower portion of the motor shaft 41, the rotor main body 42, the stator 43, and the second bearing 44b.

The motor accommodating section 32 has an annular protruding portion 32a that protrudes upward from the bottom surface of the motor accommodating section 32. Although not illustrated in the drawing, the annular protruding portion 32a has an annular shape about the central axis J1. The annular protruding portion 32a supports the outer wheel of the second bearing 44b from the lower side. The inner portion in the radial direction of the annular protruding portion 32a overlaps the inner wheel of the second bearing 44b and the lower end of the motor shaft 41 when seen in the axial direction Z. Therefore, it is possible to prevent the inner wheel of the second bearing 44b and the lower end of the motor shaft 41 from being brought into contact with the bottom surface of the motor accommodating section 32 even in a case in which the downward preload is applied to the motor shaft 41 and the inner wheel of the second bearing 44b and the lower end of the motor shaft 41 are arranged to protrude on the lower direction than the outer wheel of the second bearing 44b.

The output section holding section 33 protrudes outward in the radial direction from the motor accommodating section 32. The output section holding section 33 has a base section 33a and an output shaft holding section 33b. The base section 33a protrudes outward in the radial direction from the motor accommodating section 32. The output shaft holding section 33b protrudes on both sides in the axial direction from the outer end in the radial direction of the base section 33a. The output shaft holding section 33b has a cylindrical shape about the output central axis J3. The output shaft holding section 33b opens on both sides in the axial direction. The inside of the output shaft holding section 33b penetrates through the base section 33a in the axial direction Z.

A cylindrical bush 65 is fitted into the inside of the output shaft holding section 33b. A flange section that protrudes outward in the radial direction about the output central axis J3 is provided at the upper send of the bush 65. The flange section of the bush 65 is supported from the lower side with the upper end of the output shaft holding section 33b. A portion, which is lower than the flange section 61b, of the output shaft main body 61a is fitted into the inside of the bush 65. The bush 65 supports the output shaft 61 such that the output shaft 61 can rotate about the output central axis J3. The flange section 61b is supported from the lower side with the upper end of the output shaft holding section 33b via the flange section of the bush 65. The lower opening 61d of the output shaft 61 is arranged below the bush 65.

The stator fixing member 37 has a bottom section and has a tubular shape that opens upward. The stator fixing member 37 has a cylindrical shape about the central axis J1. The stator fixing member 37 is fitted into the inside of the motor accommodating section 32. A plurality of through-holes arranged in the circumferential direction are provided at the bottom section of the stator fixing member 37. A plurality of protruding sections provided at the bottom section of the motor accommodating section 32 are respectively fitted into the through-holes of the stator fixing member 37.

The upper end of the stator fixing member 37 protrudes above the motor accommodating section 32. The second bearing 44b is held at the bottom section of the stator fixing member 37. An outer circumferential surface of the stator 43 is fixed to the inner circumferential surface of the stator fixing member 37. The stator fixing member 37 is made of metal. The motor case 30 is created by insert molding in which resin is poured into a mold in a state in which the stator fixing member 37 is inserted into the mold, for example.

The busbar holder 90 is arranged at an upper opening of the stator fixing member 37. The busbar holder 90 has an annular shape about the central axis J1 and has a plate surface with a plate shape that is perpendicular to the axial direction Z. The busbar holder 90 holds the busbar, which is not illustrated in the drawing. The busbar holder 90 covers the upper side of the stator 43.

The disclosure is not limited to the aforementioned embodiment, and other configurations can also be employed. The preload member is not particularly limited as long as the preload member can apply a preload to the motor shaft. The preload member may be a coil spring or the like. In addition, the preload member may be brought into direct contact with the motor shaft and may apply the preload thereto. Also, a preload member that applies a preload to the motor shaft may be provided separately from a member that applies a preload to the ball bearings such as the first bearing and the like.

The support section is not particularly limited as long as the support section can support the motor shaft from the lower side. The support section may be a protruding portion that protrudes upward from the bottom section of the motor accommodating section, for example. In this case, the protruding portion is in point contact with a center of the lower end of the motor shaft, for example, and supports directly the motor shaft from the lower side.

The motor unit sensor may be a magnet sensor other than the hall element or may be a sensor other than the magnetic sensor. The motor unit sensor may be a magneto resistive element or an optical sensor, for example. The detection target section is not particularly limited and may be a detection target section other than the magnet as long as the detection target section is detected by the motor unit. The detection target section may be attached directly to the motor shaft. The same is true for the output section sensor and the like.

The housing main body may be a single member. The housing main body may be created as a single body by injection molding. In this case, the metal member is held at the housing main body after the housing main body is created. The shape of the housing main body is not particularly limited. The housing main body may have a polygonal shape, a circular shape, or an oval shape when seen in the axial direction. The housing main body may not be made of resin and may be metal, for example.

The metal member is not particularly limited. The metal member may be formed by a plurality of separate members being coupled to each other. The metal member may not be provided. The first bearing, the second bearing, the third bearing, and the fourth bearing may not be ball bearings and may be sliding bearings or the like. The configuration of the speed reducer is not particularly limited. The direction in which the output shaft extends may be different from the direction in which the motor shaft extends.

The opening, into which the driven shaft is inserted, of the output shaft may open on the upper side. The position at which the output shaft is arranged is not particularly limited.

Purposes of the electric actuator according to the aforementioned embodiment are not particularly limited, and the electric actuator may be mounted on devices other than the vehicle. Also, the aforementioned respective configurations can appropriately be combined without conflicting with each other.

Features of the above-described embodiments and the modifications thereof may be combined appropriately as long as no conflict arises.

While embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. An electric actuator, comprising:
a motor unit that has a motor shaft extending in an axial direction and a rotor main body fixed to the motor shaft;
a speed reducer that is coupled to the motor shaft;
a circuit board that is electrically connected to the motor unit and is arranged on one side in the axial direction beyond the rotor main body;
an output section that has an output shaft to which rotation of the motor shaft is delivered via the speed reducer;
a detection target section that is attached to the motor shaft;
a motor unit sensor that detects a position of the detection target section and detects rotation of the motor shaft;
a preload member that applies a preload to the motor shaft; and
a support section that supports the motor shaft on the other side in the axial direction,
wherein the motor unit has a first bearing that rotatably supports the motor shaft,
the circuit board has a through-hole through which the circuit board penetrates in the axial direction,
the motor shaft passes through the through-hole and penetrates through the circuit board in the axial direction,
the detection target section is attached to a portion, which protrudes on one side in the axial direction beyond the circuit board, of the motor shaft and faces a surface on one side in the axial direction of the circuit board in the axial direction via a gap,
the motor unit sensor is fixed to a portion, which faces the detection target section in the axial direction via a gap, of the surface on one side in the axial direction of the circuit board, and
the preload member applies the preload to the motor shaft toward the other side in the axial direction and presses the motor shaft against the support section.

2. The electric actuator according to claim 1, wherein
the first bearing is a ball bearing, and
the preload member applies the preload to the first bearing toward the other side in the axial direction and applies the preload to the motor shaft toward the other side in the axial direction via the first bearing.

3. The electric actuator according to claim 1, wherein
the first bearing supports a portion, which is on the other side in the axial direction beyond a portion to which the detection target section is attached, of the motor shaft.

4. The electric actuator according to claim 2, wherein
the first bearing supports a portion, which is on the other side in the axial direction beyond a portion to which the detection target section is attached, of the motor shaft.

5. The electric actuator according to claim 3, wherein
at least a portion of the first bearing is inserted into the through-hole.

6. The electric actuator according to claim 4, wherein
at least a portion of the first bearing is inserted into the through-hole.

7. The electric actuator according to claim 3, wherein
the motor unit has a detection target section holder that is attached to the motor shaft,
the detection target section is fixed to the detection target section holder, and
the detection target section holder has a support target portion that is supported from the other side in the axial direction at a portion of the motor shaft.

8. The electric actuator according to claim 4, wherein
the motor unit has a detection target section holder that is attached to the motor shaft,
the detection target section is fixed to the detection target section holder, and
the detection target section holder has a support target portion that is supported from the other side in the axial direction at a portion of the motor shaft.

9. The electric actuator according to claim 3, wherein
the detection target section is a magnet, and
the motor unit sensor is a magnetic sensor that detects a magnetic field of the detection target section.

10. The electric actuator according to claim 4, wherein
the detection target section is a magnet, and
the motor unit sensor is a magnetic sensor that detects a magnetic field of the detection target section.

11. The electric actuator according to claim 9, wherein
the speed reducer is coupled to one side in the axial direction of the motor shaft, and
the circuit board is disposed on one side in the axial direction of the speed reducer.

12. The electric actuator according to claim 10, wherein
the speed reducer is coupled to one side in the axial direction of the motor shaft, and
the circuit board is disposed on one side in the axial direction of the speed reducer.

13. The electric actuator according to claim 1, wherein
the preload member is a wave washer.

14. The electric actuator according to claim 2, wherein
the preload member is a wave washer.

15. The electric actuator according to claim 3, wherein
the preload member is a wave washer.

16. The electric actuator according to claim 4, wherein
the preload member is a wave washer.
